(19) United States
(12) Patent Application Publication
(10) Pub. No.: US 2012/0239772 A1
(43) Pub. Date: Sep. 20, 2012

(54) COMMUNICATION SYSTEM AND COMMUNICATING METHOD

(75) Inventor: Hitoshi Kubota, Tokyo (JP)

(73) Assignee: Mitsubishi Electric Corporation, Tokyo (JP)

(21) Appl. No.: 13/514,205

(22) PCT Filed: Jan. 14, 2011
(86) PCT No.: PCT/JP11/50565

§ 371 Date: Jun. 6, 2012

(30) Foreign Application Priority Data
Jan. 19, 2010 (JP) 2010-009027

(51) Int. Cl. G06F 15/16

(52) U.S. Cl. 709/206

(57) ABSTRACT

A communication system includes a first terminal, a second terminal, and a third terminal. The first terminal transmits message data addressed to the third terminal to plural terminals. When the second terminal receives the message data and confirms that a destination thereof is not the second terminal, the second terminal transfers the received message data. When the third terminal receives the message data and confirms that the destination thereof is the third terminal, the third terminal transmits response data corresponding to the received message data to the first terminal. A priority for transmission of the response data is set higher than that of the transferred message data, and a period of time from reception of the message data until the transmission of the corresponding response data is shorter than a period of time from reception of the message data until the transfer of the message data.

### FIELD

The present invention relates to a communication system having a plurality of communication devices, in which different priorities are set to frames to be transmitted depending on their types, and various frames are transmitted and transferred based on the priorities.

### BACKGROUND

FIG. 7 depicts operations of communication devices in a conventional communication system.

In a conventional route-searching method, when a communication device 2 searches for a communication route to another communication device 4 in an ad-hoc network, the communication device 2 transmits to its neighboring communication devices 1, 3, and 5, a route-search message addressed to the communication device 4. The communication device 4 having received the route-search message addressed to the communication device 4 itself transmits a route-search response message to the communication device 2 that is a transmission source. The communication devices 1, 3, and 5 having received the route-search message not addressed to the devices themselves transfer the received route-search message to their neighboring communication devices (communication devices 2 to 4 in the case of the communication device 5).

In this manner, the communication devices 1 and 3 to 5 having received the route-search message transmitted from the communication device 2 intend to transmit the route-search message or the route-search response message at the same timing, and therefore a frame (transmission data, message data) collision is likely to occur on a transmission medium (a radio communication line), which raises the possibility that the route-search response message transmitted from the communication device 4 is not properly received by the destination communication device 2.

FIG. 8 depicts frame transmission timings of a conventional communication device.

According to the IEEE 802.11e wireless LAN standard, transmission timings of various frames are different depending on frame types. Furthermore, a random transmission waiting time provided to each communication device suppresses occurrence of a frame collision on a transmission medium.

In a media access method (IEEE 802.11e wireless LAN standard) that enables a communication terminal to access a communication medium according to CSMA/CA (Carrier Sense Multiple Access/Collision Avoidance), a plurality of frame transmission intervals (inter-frame spaces (IFSs)) are defined thereby to perform preferential control of media accesses (wireless communication timings) depending on the types of frames.

According to the IEEE 802.11e, the IFSs defined therein include a short inter-frame space (SIFS) used for transmission of an Ack signal for a certain frame, a point coordination function inter-frame space (PIFS) used for transmission of a polling frame that is transmitted from an arbitrary access point to each terminal, a distributed coordination function inter-frame space (DIFS) used for transmission of a data frame, and an arbitration inter-frame space (AIFS) by which different frame spaces can be set depending on an access category (AC) corresponding to the frame's priority.

In this manner, the frame transmission intervals are differentiated depending on the frame types, and a higher-priority frame is transmitted at an earlier timing, thereby providing preferential control based on the types of frames to be transmitted.

As shown in FIG. 7, the communication terminals 1 and 3 to 5 having received the route-search message at the same time from the communication device 2 intend to transmit the route-search message, (transfer) or the route-search response message (a next frame) substantially at the same time. To these communication terminals 1 and 3 to 5, different numbers of slot times within a contention window that is constituted by a plurality of the slot times set in advance are assigned for the route-search message (a data frame, a busy medium) transmitted from the communication device 2 after the DIFS or the AIFS has passed. Based on the slot times, a next frame to be transmitted from each communication terminal is transmitted. In this way, different numbers of the slot times are assigned to the respective communication terminals and thus different transmission waiting times are randomly provided to the respective communication terminals, which suppress multiple frame collisions caused because the plural communication terminals transmit the data frame at the same timing.

When a communication device (A) has transmitted a frame (A) based on the slot times assigned thereto and then the transmission of the frame (A) from the communication device (A) is not completed even after the slot times of another communication device (B) have passed, the communication device (B) refrains the transmission of a frame (B) intended to be transmitted. After the transmission of the frame (A) is completed, an arbitrary number of slot times within a next contention window set anew following the frame (A) is assigned to the communication device (B).

According to a method of providing the contention window in the conventional technology, when the SIFS, the PIFS, or the DIFS is set to a busy medium as a frame previously transmitted, the corresponding contention window involves a long transmission waiting time, which means that there are provided many slot times.

When an i^{th}-priority AIFS is set to a previous busy medium, the corresponding contention window is shorter and involves less slot times than that in the case of the SIFS, the PIFS, or the DIFS. However, the slot times in the contention window corresponding to the SIFS, the PIFS, or the DIFS and the slot times in the contention window corresponding to the AIFS are provided in such a manner that some of the slot times in the both contention windows overlap with each other in timing, and therefore, on actual transmission of the next frame, a higher-priority frame may be transmitted later than a comparatively lower-priority frame that is to be transmitted after the AIFS.

When a j^{th}-priority AIFS is set to a previous busy medium, the corresponding contention window is much shorter and involves much less slot times than those in the case of the i^{th}-priority AIFS. However, the slot times in the contention window corresponding to the i^{th}-priority AIFS and those corresponding to the j^{th}-priority AIFS are set in such a manner that some of the slot times in the both contention windows overlap with each other in timing, and therefore, on actual transmission of a next frame, a comparatively higher-priority frame may be transmitted later than a comparatively lower-priority frame that is to be transmitted after the j^{th}-priority AIFS.

### CITATION LIST

### Non Patent Literature

Non Patent Literature 1: IEEE Standard 802.11

### SUMMARY

### Technical Problem

As described above, the length of the contention window is set differently depending on priorities of frames, in which there is a problem that a higher-priority frame is not always transmitted preferentially because the contention windows set for frames with different priorities are provided to partially overlap with another one in timing.

The present invention has been achieved to solve the above problems and an object of the present invention is to obtain a communication system and a communicating method in which contention windows set for frames having different priorities do not overlap with one another in timing, thereby ensuring that a higher-priority frame is always transmitted preferentially.

### Solution to Problem

In order to solve above-mentioned problems and achieve the object of the present invention, according to an aspect of the present invention, there is provided a communication system comprising: a first communication terminal; a second communication terminal; and a third communication terminal, wherein the first communication terminal transmits message data addressed to the third communication terminal to a plurality of communication terminals, the second communication terminal receives the message data, confirms a destination of the received message data, and transfers the received message data to other communication devices when the confirmed destination is not the second communication terminal itself, the third communication terminal receives the message data, confirms the destination of the received message data, and transmits response data corresponding to the received message data to the first communication terminal that is a transmission source of the received message data when the confirmed destination is the third communication terminal itself, a priority for transmission of the response data is set higher than that of the transferred message data, and a period of time from reception of the message data until the transmission of the corresponding response data is shorter than a period of time from reception of the message data until transfer of the message data.

### ADVANTAGEOUS EFFECTS OF INVENTION

According to the communication system of the present invention, the transfer of high-priority data can be carried out always earlier than the transfer of low-priority data.

### BRIEF DESCRIPTION OF DRAWINGS

FIG. 1 depicts frame transmission timings in a communication device according to the present invention.

FIG. 2 depicts operations of communication devices in a communication system to which the present invention is applied.

FIG. 3 is a schematic diagram of data transmitted by the communication devices in the communication system to which the present invention is applied.

FIG. 4 depicts frame transmission timings in a communication device according to a second embodiment of the present invention.

FIG. 5 depicts frame transmission timings in a communication device according to a third embodiment of the present invention.

FIG. 6 depicts frame transmission timings in a communication device according to a fourth embodiment of the present invention.

FIG. 7 depicts operations of communication devices in a conventional communication system.

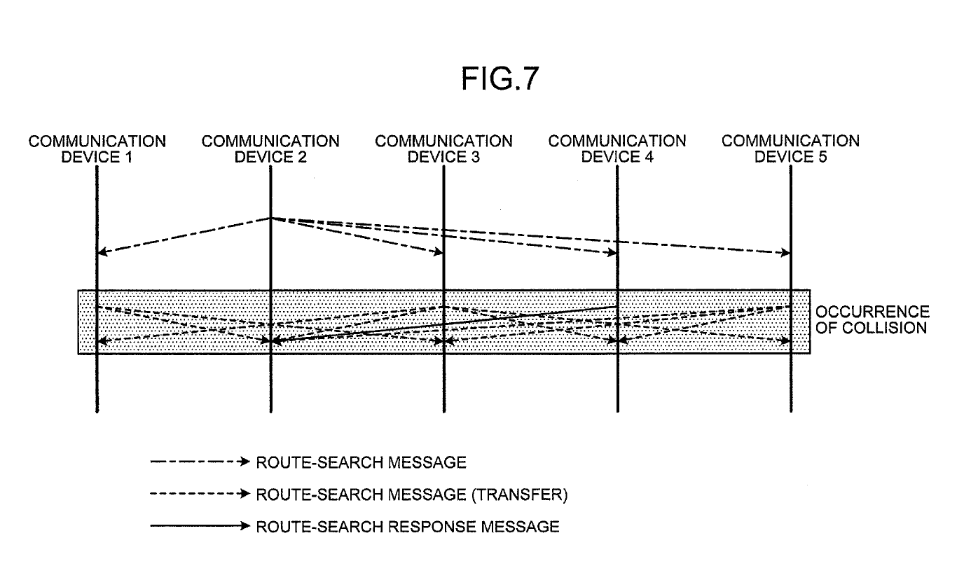

FIG. 8 depicts frame transmission timings in the conventional communication system.

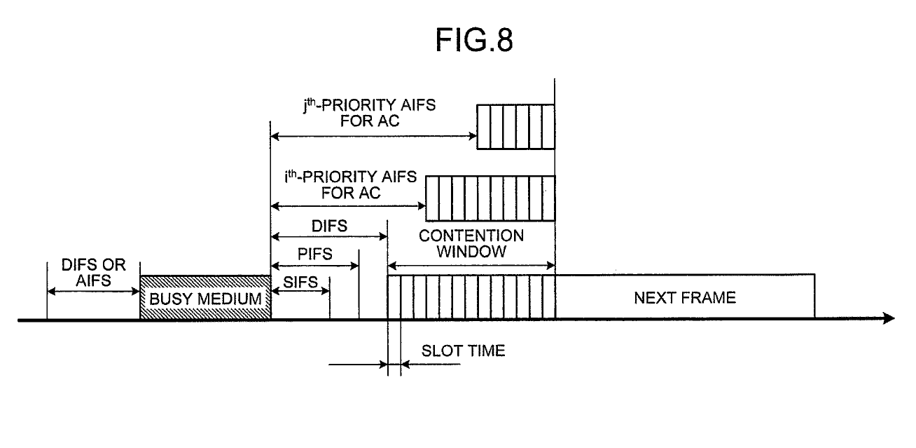

### DESCRIPTION OF EMBODIMENTS

Exemplary embodiments of a communication system and a communicating method according to the present invention will be explained below in detail with reference to the accompanying drawings. The present invention is not limited to the embodiments.

### First Embodiment

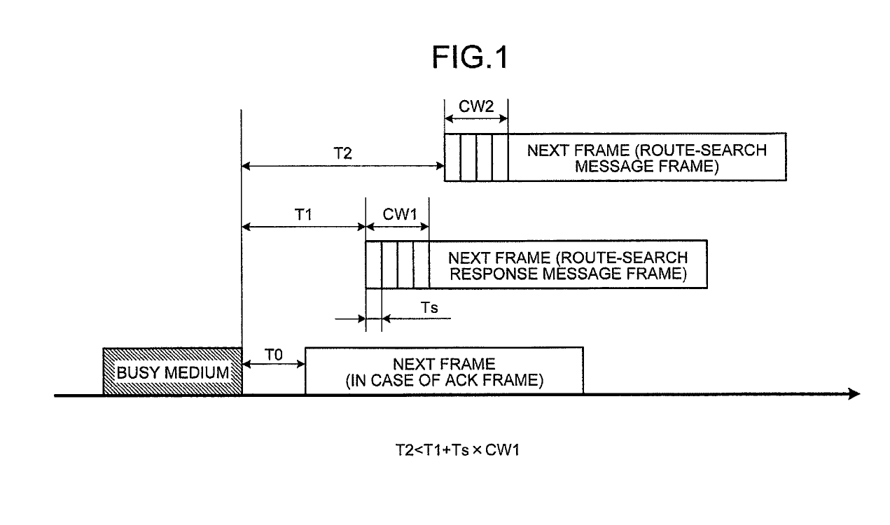

FIG. 1 depicts frame transmission timings in a communication device (a communication terminal) according to the present invention.

As shown in FIG. 1, when T0 denotes a transmission interval to a next frame (an Ack frame, for example) corresponding to a busy medium (a previous frame), T1 denotes an (transmission time) interval until transmission of a next frame such as a route-search response message corresponding to the busy medium, CW1×Ts denotes a contention window corresponding to a transmission waiting time for the next frame such as the route-search response message, T2 denotes an (transmission time) interval until transmission of a next frame such as a route-search message corresponding to the busy medium, CW2×Ts denotes a contention window corresponding to a transmission waiting time for the next frame such as the route-search message, and Ts denotes each of a plurality of slot times constituting the contention windows, conditions of T0<T1 and T1+Ts×CW1<T2 are established.

That is, priorities (priority orders) are provided to the next frame such as the Ack frame, the next frame such as the route-search response message, and the next frame such as the route-search message in the descending order, by which the next frame such as the route-search response message is transmitted more preferentially than the next frame such as the route-search message, and the next frame such as the Ack frame is transmitted more preferentially than the next frame such as the route-search response message.

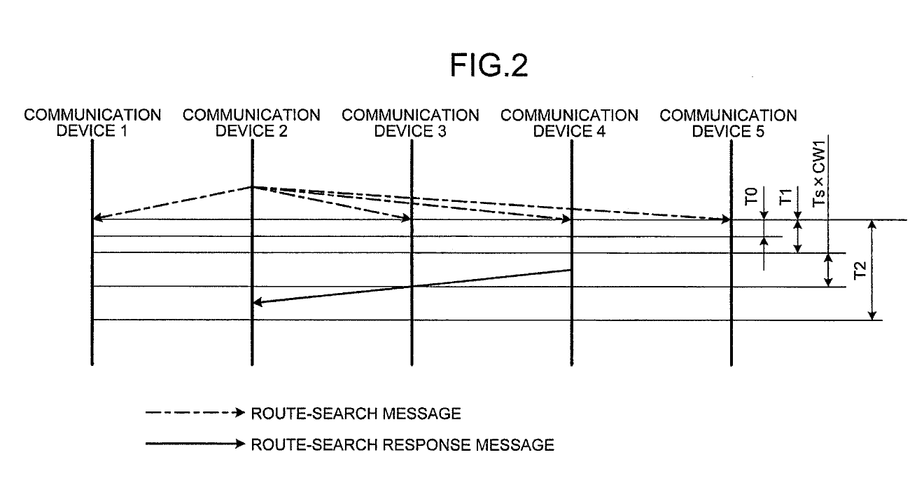

FIG. 2 depicts operations of communication devices in a communication system to which the present invention is applied.

Communication devices 1 to 5, which access a communication medium (radio communication) according to CSMA/CA, (usually) wait to receive a transmission signal transmitted from a certain communication device, refrain transmission of a transmission signal that is to be transmitted from the devices themselves upon reception of the transmission signal transmitted from the certain communication device, and then transmitted the transmission signal of the devices themselves after confirming that the transmission of the transmission signal from the certain communication device has completed.

It is assumed here that the communication device 2 transmits a route-search message (a frame) to search a communication route to the communication device 4.

When the communication device 2 transmits the route-search message, the communication devices 1 and 3 to 5 receive this route-search message. The communication devices 1, 3, and 5 confirm a destination of the received route-search message, and when recognizing that the route-search message is not addressed to the devices themselves, these devices transfer the received route-search message to their neighboring communication devices. The communication device 4 confirms the destination of the received route-search message, and when recognizing that the route-search message is addressed to the communication device 4 itself, returns a route-search response message (measurement data, for example) corresponding to the received route-search message to the communication device 2.

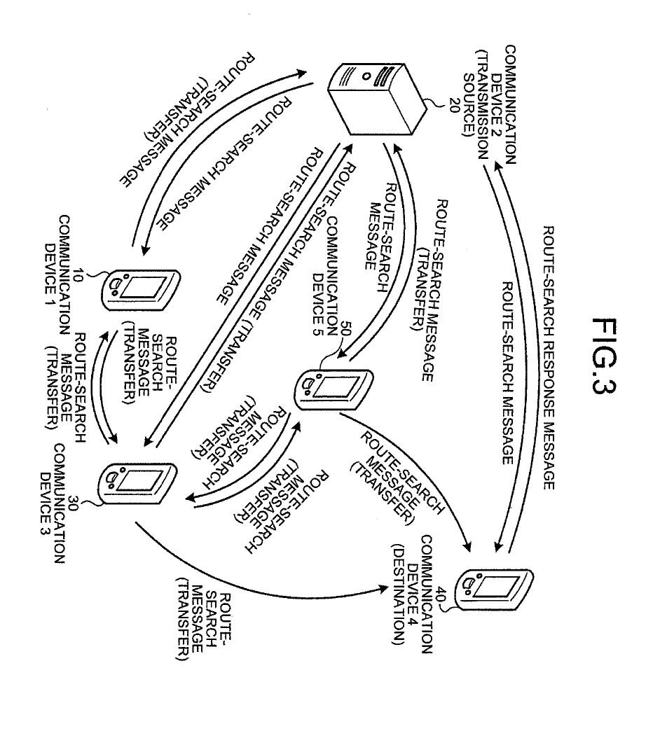

The same operations are shown also in FIG. 3.

The system according to the present invention includes the communication device 1 (10), the communication device 2 (20), the communication device 3 (30), the communication device 4 (40), and the communication device 5 (50). In this case, the communication device 2 (20) is a transmission source of a route-search message, and transmits the route-terminal message to the communication terminal 4 (40). Upon reception of the route-search message transmitted from the communication device 2 (20), the communication terminal 1 (10), the communication terminal 3 (30), and the communication terminal 5 (50) recognize that the route-search message is not transmitted to these terminals themselves, and then transfer the route-search message (transfer) to their neighboring communication devices. When the communication device 4 (40) receives the route-search message transmitted from the communication device 2 (20), the communication terminal 4 recognizes that the route-search message is transmitted to the communication terminal 4 itself (a destination), and then transmits a route-search response message to the communication terminal 2 (20: a transmission source).

While the communication device according to the present invention transfers the received route-search message to the neighboring communication devices when recognizing that the route-search message is not addressed to the communication device itself, an identification number can be provided to each frame such as the route-search message, to avoid repeated transfer when the frame with the same identification number is received again. Alternatively, a time (a period) in which the frame with the same identification number is receivable can be set. This can avoid an abrupt increase in the number of transmitted frames and unnecessary traffic congestions on communication lines.

As for timings of the transfer of the route-search message from the communication devices 1, 3, and 5 in response to the route-search message (the busy medium) transmitted from the communication device 2, a timing based on each slot time within the contention window starting after a lapse of the time T2 from the reception of the busy medium until a time corresponding to T2+CW2×Ts is allocated to each communication device. As for a timing of the transmission of the route-search response message from the communication device 4, a timing based on each slot time within the contention window starting after a lapse of the time T1 from the reception of the busy medium until a time corresponding to T1+CW1×Ts is allocated. The time corresponding to T1+CW1×Ts is earlier (shorter) than the time T2 that is the transfer timing of the route-search message from the communication devices 1, 3, and 5, so that the route-search response message from the communication device 4 is handled (transferred) always earlier than the transfer of the route-search message from the communication devices 1, 3, and 5.

That is, when the communication devices 1 and 3 to 5 receive the route-search message transmitted from the communication device 2, the communication device 4 starts transmitting the route-search response message in response to the received route-search message within a predetermined period of time (T1 to T1+CW1×Ts), and the communication devices 1, 3, and 5 start transferring the route-search message at a timing (T2 to T2+CW2×Ts) later than the transmission timing (T1 to T1+CW1×Ts) of the route-search response message. Therefore, the route-search response message transmitted from the communication device 4 can be satisfactorily reached to the communication device 2 without competing (colliding) with the route-search message transmitted from the communication devices 1, 3, and 5.

When the communication device 4 returns (starts transmitting) the route-search response message to the communication device 2, the communication devices 1, 3, and 5 detect that the transmission of the route-search response message is in progress, and suspend the transfer of the route-search message until the communication device 4 completes the transmission of the route-search response message.

The present invention is applicable to a data collecting system such as an automatic meter-reading system using an ad-hoc network. For application to such a system, the following points are considered.

1. A route-search response message is usually transmitted from one communication terminal, and there is basically no case that a route-search response message is transmitted from plural communication terminals (substantially at the same time). Further, there is a low possibility that the present communication system competes with other communication systems.

2. When the route-search message has reached a destination (target) communication terminal, the route-search message does not need to be (relayed and) transferred further to other communication terminals. Therefore, the necessity of providing a priority to the transmission of the route-search response message is higher than that of the transfer of the route-search message. When the route-search response message is transmitted, the transmission is controlled to avoid the competition (collision) with the route-search message transmitted from other communication terminals.

Therefore, the frame intervals (T1 and T2) and the contention windows (CW1×Ts and CW2×Ts) have to be set to prevent the collision of the frames caused by simultaneous transmission from the communication terminals.

In this manner, by delaying the beginning of the contention window related to the low-priority route-search message (a frame) to be later than the end of the contention window for the high-priority route-search response message (a frame), the transmission of the high-priority route-search response message (from the communication device 4 to the communication device 2) can be ensured.

### Second Embodiment

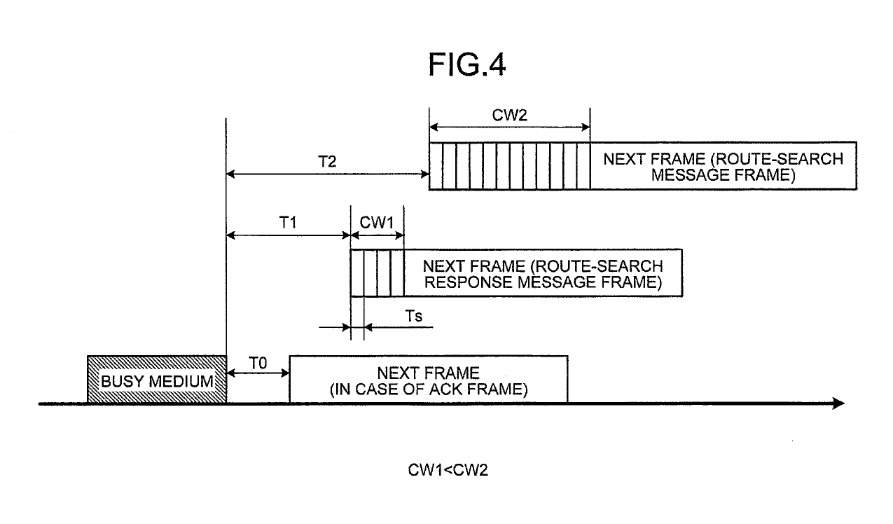

FIG. 4 depicts frame transmission timings in a communication device according to a second embodiment.

As shown in FIG. 4, when TO denotes the transmission interval to a next frame (an Ack frame, for example) corresponding to a busy medium (a previous frame), T1 denotes the (time) interval until transmission of a next frame such as the route-search response message corresponding to the busy medium, CW1×Ts denotes a contention window corresponding to a transmission waiting time for the next frame such as the route-search response message, T2 denotes the (time) interval until transmission of a new frame such as the route-search message from the busy medium, CW2×Ts denotes the contention window corresponding to the transmission waiting time for the next frame such as the route-search message, and Ts denotes each of plural slot times constituting the contention windows, conditions of T0<T1, T1+Ts×CW1<T2, and CW1<CW2 are established.

The route-search message (a frame) is relayed (transferred to the neighboring communication devices) by plural communication devices, and therefore competition (of various frames) easily occurs during the relay.

That is, the route-search messages received by the communication terminals are intended to be transmitted to other communication terminals substantially at the same time, which greatly raises the possibility of competition (collision) of the route-search messages transmitted from the communication terminals. Therefore, it is desirable to increase the number of slots in the contention window (CW2).

By setting the number CW2 of the slots in the contention window larger (more), the possibility of the collision of the route-search message is lowered, thereby easily ensuring the transmission of the route-search message to the target communication device.

Meanwhile, because the route-search response message is transmitted from one communication device that is the destination of the route-search message, the possibility of the competition is low.

Accordingly, by setting the number CW1 of the slots in the contention window for the route-search response message smaller (less), it is possible to suppress lowering in throughput of the route-search response message.

As described above, the beginning of the contention window of the route-search message is delayed to be later than the end of the contention window of the route-search response message, and further, the number CW2 of the slots in the contention window of the route-search message is set larger (more) than the number CW1 of the slots in the contention window of the route-search response message, thereby more securely transmitting the route-search message without lowering the throughput of the route-search response message.

### Third Embodiment

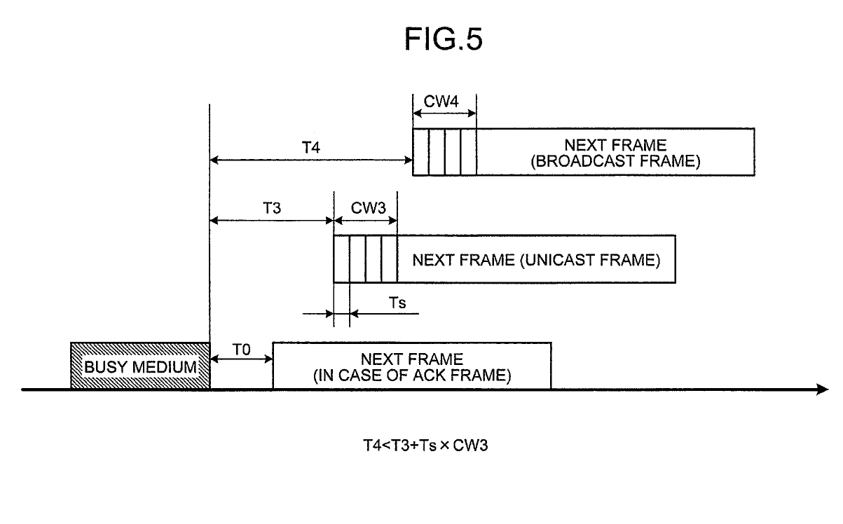

FIG. 5 depicts frame transmission timings in a communication device according to a third embodiment.

As shown in FIG. 5, when TO denotes a transmission interval until a next frame (an Ack frame, for example) corresponding to a busy medium (a previous frame), T3 denotes a transmission interval of a unicast frame that is transmitted to one (direction) in response to the busy medium, CW3×Ts denotes a contention window corresponding to a transmission waiting time for the unicast frame, T4 denotes a transmission interval of a broadcast frame that is transmitted to plural (directions) in response to the busy medium, CW4×Ts denotes a contention window corresponding to a transmission waiting time for the broadcast frame, and Ts denotes each of the plural slot times constituting the contention windows, conditions of T0<T3 and T3+CW3<T4 are established.

As shown in FIG. 2, when searching for the communication route to the communication device 4, the communication device 2 transmits via broadcast the route-search message related to the communication device 4 to the neighboring communication devices of the communication device 2. The communication devices 1, 3, and 5 having received the route-search message whose destination is not the devices themselves further transfer (broadcast) the received route-search message to their neighboring communication devices. The communication device 4 having received the route-search message whose destination is the communication device 4 itself transmits the route-search response message via unicast to the communication device 2.

In this manner, the high-priority route-search response message and the low-priority route-search message are communicated by the unicast frame and by the broadcast frame, respectively, and the beginning of the contention window related to the (low-priority) broadcast frame is delayed to be behind the end of the contention window related to the (high-priority) unicast frame, so that the high-priority route-search response message can be securely transmitted.

### Fourth Embodiment

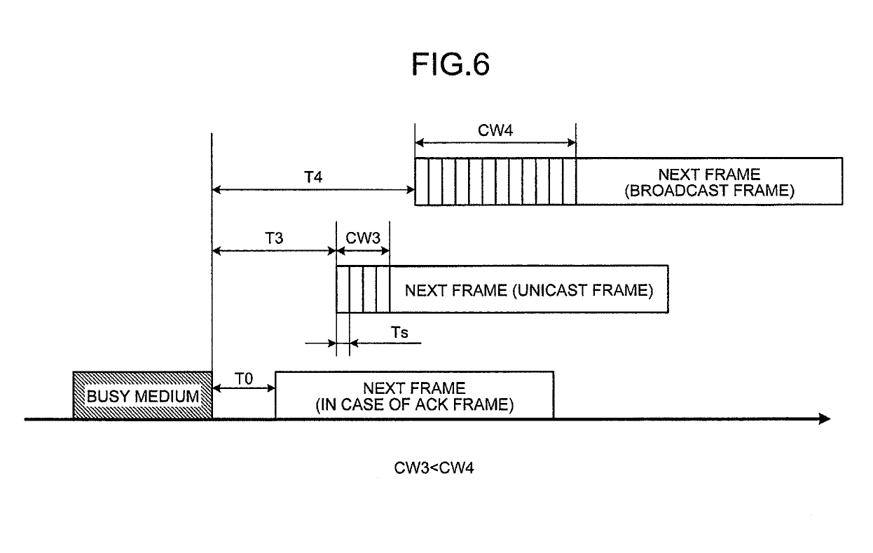

FIG. 6 depicts frame transmission timings in a communication device according to a fourth embodiment.

As shown in FIG. 6, when TO denotes a transmission interval until a next frame (an Ack frame, for example) corresponding to a busy medium (a previous frame), T3 denotes a transmission interval of a unicast frame that is transmitted to one (direction) in response to the busy medium, CW3×Ts denotes a contention window corresponding to a transmission waiting time for the unicast frame, T4 denotes a transmission interval for a broadcast frame that is transmitted to plural (directions) in response to the busy medium, CW4×Ts denotes a contention window corresponding to a transmission waiting time for the broadcast frame, and Ts denotes each of the plural slot times constituting the contention windows, conditions of T0<T3, T3+Ts×CW3<T4, and CW3<CW4 are established.

It is difficult to confirm whether the message transmitted by the broadcast frame has reached the destination communication device; however, by setting the number of the slots in the contention window larger (more), the possibility of collision of the broadcast frame can be lowered. In this manner, by lowering the possibility of the collision of the broadcast frame, the reachability of the message to the destination communication device can be increased. Further, the broadcast frame is used for (frame) transmission to many communication devices. In the present communication system, it is used for transmission of the route-search message for network management. During the transmission of this route-search message, delay is comparatively allowable.

The unicast frame enables easy confirmation by an Ack signal, for example, whether the message has reached a destination communication device, and when it is detected that the message has not reached the destination communication device, this message can be re-transmitted to increase the reachability of the message to the destination communication device. Furthermore, the unicast frame is used for (frame) transmission to a specified communication device. In the present communication system, it is used for transmission of the route-search response message for network management and for transmission and reception of automatic meter-reading data. During the transmission of the route-search response message and the automatic meter-reading data in the present communication system, it is preferable to minimize delay in the transmission. Further, upon collecting the automatic meter-reading data (between the transmission source and other communication devices), there is not such a high possibility that the unicast frame is transmitted from the communication devices at the same time.

Therefore, also when the number of the slots in the contention window for the unicast frame is set smaller (less), a high reachability of the message to the destination communication device can be obtained.

Moreover, by setting the number of the slots in the contention window for the unicast frame to smaller (less), the frame transmission interval of the unicast frame can be reduced, so that the throughput of the unicast frame can be enhanced.

As shown in FIG. 2, when the communication device 2 searches for the communication route to the communication device 4 and thus transmits the route-search message related to the communication device 4 via broadcast to the neighboring communication devices of the communication device 2, the communication device 4 having received the route-search message directed thereto transmits the route-search response message to the communication device 2 via unicast, and the communication devices 1, 3, and 5 having received the route-search message not directed thereto transfer the received route-search message to their neighboring communication devices via broadcast.

As described above, the beginning of the contention window for the unicast frame is delayed to be behind the end of the contention window for the broadcast frame, the number CW2 of the slots in the contention window for the broadcast frame is set larger (more) than the number (CW1) of the slots in the contention window for the unicast frame, and further, the high-priority route-search response message is transmitted by the unicast frame, and the low-priority route-search message is transmitted by the broadcast frame, thereby more securely transmitting the route-search response message without lowering the throughput of the route-search response message.

### REFERENCE SIGNS LIST

10 COMMUNICATION TERMINAL 1
20 COMMUNICATION TERMINAL 2
30 COMMUNICATION TERMINAL 3
40 COMMUNICATION TERMINAL 4,
50 COMMUNICATION TERMINAL 5

1. A communication system for communicating with a plurality of communication terminals by using an ad-hoc network comprising:
a first communication terminal;
a second communication terminal; and
a third communication terminal, wherein
the first communication terminal transmits message data addressed to the third communication terminal to a plurality of communication terminals,
the second communication terminal receives the message data, confirms a destination of the received message data, and transfers the received message data to other communication devices when the confirmed destination is not the second communication terminal itself,
the third communication terminal receives the message data, confirms the destination of the received message data, and transmits response data corresponding to the received message data to the first communication terminal that is a transmission source of the received message data when the confirmed destination is the third communication terminal itself,
a priority for transmission of the response data is set higher than that of the transferred message data, and
a period of time from reception of the message data until the transmission of the corresponding response data is shorter than a period of time from reception of the message data until transfer of the message data.

2. The communication system according to claim 1, wherein
as a period of time from reception of the message data by a certain communication terminal until transmission of the corresponding response data, a contention window (CW1×Ts) is provided after a lapse of a transmission interval (T1),
as a period of time from reception of the message data by another communication terminal until transfer of the message data, a contention window (CW2×Ts) is provided after a lapse of a transmission interval (T2), and
a timing of end of the contention window (CW1×Ts) for the response data is earlier than a timing of beginning of the contention window (CW2×Ts) used for the transfer of the message data.

3. The communication system according to claim 2, wherein
a contention window (CW*×Ts) is constituted of a product of number (CW*) of slots and a predetermined time interval (slot time (Ts)), and
number (CW1) of the slots in the contention window (CW1×Ts) for the response data is smaller than number (CW2) of the slots in the contention window (CW2×Ts) used for transfer of the message data.

4. The communication system according to claim 1, wherein
a broadcast frame transmittable to the plural communication terminals is used for the transmission of the message data, and
a unicast frame to be transmitted to one communication terminal is used for the transmission of the response data corresponding to the message data.

5. A communicating method in a communication system for communicating with a plurality of communication terminals by using an ad-hoc network, the method comprising:
transmitting message data addressed to a third communication terminal to a plurality of communication terminals by a first communication terminal;
receiving the message data, confirming a destination of the received message data, and transferring the received message data to other communication devices by a second communication terminal when the confirmed destination is not the second communication terminal itself; and
receiving the message data, confirming the destination of the received message data, and transmitting response data corresponding to the received message data to the first communication terminal that is a transmission source of the received message data by the third communication terminal itself when the confirmed destination is the third communication terminal itself, wherein
a priority for transmission of the response data is set higher than that of the transferred message data, and
a period of time from reception of the message data until transmission of the corresponding response data is shorter than a period of time from reception of the message data until transfer of the message data.

6. A communication terminal of a communication system using an ad-hoc network, the terminal confirming a destination of message data from a communication terminal that is a transmission source, when receiving the message data and transferring the received message data to other terminals when the confirmed destination is not the communication terminal itself, while transmitting response data corresponding to the received message data to the communication terminal as the transmission source when the confirmed destination is the communication terminal itself, wherein
a period of time from reception of the message data until transmission of the corresponding response data is shorter than a period of time from reception of the message data until transfer of the message data.
